(19) United States
(12) Patent Application Publication
(10) Pub. No.: US 2024/0366468 A1
(43) Pub. Date: Nov. 7, 2024

(54) SYSTEMS AND METHODS FOR SINGLE OR MULTISENSORY STIMULATION TO IMPROVE PATIENT EXPERIENCE AND TOLERABILITY DURING AWAKE OR MINIMAL SEDATION PROCEDURES

(71) Applicant: University of Virginia Patent Foundation, Charlottesville, VA (US)

(72) Inventors: Claudia N. Gutierrez, Charlottesville, VA (US); Logan F. McColl, Columbus, OH (US); Zoe Roecker, Charlottesville, VA (US)

(21) Appl. No.: 18/656,393

(22) Filed: May 6, 2024

Related U.S. Application Data
(60) Provisional application No. 63/464,024, filed on May 4, 2023.

(51) Int. Cl. A61H 23/02

(52) U.S. Cl. CPC A61H 23/02; A61H 2201/0157; A61H 2201/10; A61H 2201/1207; A61H 2201/1611; A61H 2201/1647; A61H 2201/165; A61H 2201/169; A61H 2201/501; A61H 2201/5048; A61H 2201/5058; A61H 2205/04; A61H 2230/065

(57) ABSTRACT

Various examples are provided related to single or multisensory stimulation to improve patient experience and tolerability during awake or minimal sedation procedures. In one example, a system includes a vibratory array including first and second vibration sources coupled to an adjustable support structure for positioning about a procedure site; and a control unit communicatively coupled to the first and second vibration sources. Vibrational frequency of the vibration sources is controlled by the control unit. The multisensory system can also include an AR headset and a computing device to provide content on the AR headset. In another example, a method for stimulation during an awake or minimal sedation procedure includes providing a vibratory array; positioning the vibration sources on an individual about a procedure site; and adjusting the vibrational frequency of the vibration sources based upon stress, pain, discomfort, and/or anxiety level of the individual during the procedure.

### CROSS REFERENCE TO RELATED APPLICATIONS

This application claims priority to, and the benefit of, U.S. provisional application entitled “System and Method for a Multisensory Device that Includes Augmented Reality and Vibroacoustic Stimulation to Improve Patient Experience and Tolerability during Awake Procedures” having Ser. No. 63/464,024, filed May 4, 2023, which is hereby incorporated by reference in its entirety.

### BACKGROUND

As health care costs in the US have continued to rise, one cost-effective evolution in care has been the proliferation of in-office procedures and surgeries across medical and surgical specialties. In-office procedures (IOPs) are defined as those performed without anesthetic or with local anesthetic and/or additional sedation, with no general anesthesia requiring endotracheal intubation and/or ventilatory support. The benefits of IOPs to medical professionals include higher procedural volume, decreased cost, and improved patient safety and outcomes through avoidance of general anesthesia. Benefits to patients receiving IOPs include decreased cost, decreased time needed for treatment, ability to drive home on the day of the procedure, and improved patient safety. While IOPs are safe and effective, patients can experience significant discomfort due to the sensitive anatomic structures involved.

In the field of laryngology, a study assessing patient discomfort across various laryngology IOPs found that approximately 40% of patients reported moderate discomfort during endoscope placement, injection, and laser ablation. This study also found that greater than 10% of patients experienced severe discomfort during the procedure. Patients are often so dissatisfied with their in-office experience that they will elect to have any follow up procedures in the OR under general anesthesia. This pattern extends to other medical specialties as well.

### SUMMARY

Aspects of the present disclosure are related to single or multisensory stimulation to improve patient experience and tolerability during awake and/or minimal sedation procedures. In one aspect, among others, a single or multisensory system comprises a vibratory array comprising: first and second vibration sources coupled to an adjustable support structure for positioning about a procedure site; and a control unit communicatively coupled to the first and second vibration sources, where vibrational frequency of the first and second vibration sources is controlled by the control unit. In one or more aspects, the first and second vibration sources can each comprise an electrical drive configured to generate vibrations at the vibrational frequency. The electrical drive can be a DC vibration motor. The first and second vibration sources can comprise a casing enclosing the electrical drive. The casing can be sealed in a silicone cover. A surface of the casing can be contoured to match a corresponding surface to which the vibrational source is applied. The casing can comprise a concave surface. The vibratory array can comprise a third vibration source.

In various aspects, the control unit can comprise a control interface configured to allow a user to control operation of the first and second vibrational sources. The control unit can comprise a power source for the first and second vibrational sources. The single or multisensory system can comprise an augmented reality (AR) system comprising: an AR headset comprising a speaker configured to provide acoustic stimulation; and a computing device communicatively coupled to the AR headset, wherein the computing device is configured to executed applications to provide content for display on the AR headset. The computing device can execute an interactive application for display on the AR headset.

In another aspect, a method for single or multisensory stimulation during an awake or minimal sedation procedure comprises providing a vibratory array comprising: first and second vibration sources coupled to an adjustable support structure; and a control unit communicatively coupled to the first and second vibration sources, where vibrational frequency of the first and second vibration sources is controlled by the control unit; positioning the first and second vibration sources on an individual about a procedure site; and adjusting the vibrational frequency of the first and second vibration sources based upon stress, pain, discomfort, or anxiety level of the individual during the awake or minimal sedation procedure. In one or more aspects, a surface of the first and second vibration sources can be contoured to match a surface of the first and second vibration sources are applied.

In various aspects, the first and second vibration sources can be positioned on opposite sides of the procedure site. The vibrational frequency can be adjusted by the individual based upon their sensed stress or anxiety level. The control unit comprises a user interface configured to allow the individual to control operation of the first and second vibrational sources. The control unit can adjust the vibrational frequency based upon feedback provided through patient monitoring. The method can comprise positioning an AR headset on the individual; and providing content for display on the AR headset during the awake or minimal sedation procedure. The content can be interactive content prompting feedback from the individual. The AR headset can provide acoustic stimulation.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of a single or multisensory system, in accordance with various embodiments of the present disclosure.

FIGS. 2A-2D illustrates examples of a vibratory array of the single or multisensory system of FIG. 1, in accordance with various embodiments of the present disclosure.

FIG. 3 illustrates an example of an augmented reality (AR) application for use with the single or multisensory system of FIG. 1, in accordance with various embodiments of the present disclosure.

FIG. 4 is a schematic block diagram of an example of a computing device that can be utilized with the single or multisensory system of FIG. 1, in accordance with various embodiments of the present disclosure.

### DETAILED DESCRIPTION

Disclosed herein are various examples related to single or multisensory stimulation to improve patient experience and tolerability, defined as more tolerable, less painful, less stressful, and/or less anxiety, during awake and/or minimal sedation procedures. Reference will now be made in detail to the description of the embodiments as illustrated in the drawings, wherein like reference numbers indicate like parts throughout the several views.

In-office procedures (IOPs) represent a cost-effective and safe alternative to operating room (OR) procedures for a myriad of disease processes across medical and surgical specialties. IOPs are performed at most under local anesthetic with additional minimal sedation, without general anesthesia or sedation to a level which would require ventilatory support, resulting in faster and often safer procedures by eliminating risks and time associated with general endotracheal anesthesia. IOPs are primarily limited by patient tolerance, as there is a lack of currently available nonpharmacologic treatment options for patient anxiety, stress, discomfort, and pain during these procedures.

Another benefit of IOPs is the increased patient autonomy they offer, as patients are awake, aware of their surroundings, and able to communicate with their physician during procedures. By providing a means of patient-controlled pain management, the patient's autonomy can be restored by eliminating the need for general endotracheal anesthesia in the OR and improving tolerability of awake or minimal sedation procedures. A barrier to the further proliferation and adoption of IOPs is the lack of non-pharmacological interventions to improve patient anxiety, stress, discomfort, and perception of pain during these procedures.

The Gate Control Theory of Pain postulates that only a limited amount of simultaneous sensory stimuli can be processed by the central nervous system and therefore nonpainful stimuli, such as vibration or virtual distraction (e.g., virtual or augmented reality) can eliminate or lessen the perception of concurrent painful stimuli. The use of these non-painful stimuli has been shown to have clinical utility in the setting of procedures such as percutaneous injections and painful wound dressing changes in burn patients. However, certain singular sensory distraction techniques and the coupling of multiple sensory distraction techniques has not been described for IOPs. The focus of the invention is to improve patient experience during IOPs utilizing a novel vibratory stimulation device with or without original AR software applications and/or acoustic stimulation.

Different ways have been found to utilize virtual reality (VR) and AR as tools to help distract patients during painful or highly stimulating procedures. At Stanford University, in a retrospective pediatric cohort aimed to distract patients during painful procedures, it was found that 100% of the patients who were in the VR group were less resistant to undergoing treatment pre- and post-operation than control groups. In most clinical settings, AR is preferred because it preserves the patient's ability to see and interact with their surroundings and medical professionals. A small case study performed in 2020 with three pediatric patients (ages 11 to 17) to assess the use of AR during otolaryngologic IOPs in reducing anxiety. At the conclusion of the study, the patients, their parents, and the otolaryngologists all recommended the use of AR based on their experiences. These studies have shown preliminary findings that VR and AR can be useful components in non-pharmacologic modes of improving patient experience.

Here, a multisensory system is referred to as the patient augmented reality and vibroacoustic array (PARVA) which aims to reduce patient discomfort (described as pain, anxiety, or stress) during in-office procedures with the ultimate goal of reducing the conversion rate of procedures to the operating room, which can save both time and money. While this disclosure of the PARVA is presented in the context of the field of laryngology, many fields of medicine employ the use of IOPs and this device can be used for other procedures, interventions, or patient care events causing discomfort, anxiety, and/or pain as can be appreciated by one of skill in the art. This solution is widely generalizable across medical and surgical specialties yielding a wide-ranging scope of benefit and potential market. A modular (or add-on) vibratory wearable device with AR application integration can yield a large, novel benefit and translate into enhanced patient-experience applicable to IOPs across many different specialties.

The Gate Control Theory of Pain developed by Mezlack and Wall in 1965 asserts that the central nervous system can only process a limited number of stimuli at one time. It postulates that non-painful stimuli, such as vibration, which activate non-nociceptive sensory neurons can interfere with signals from pain receptors, thereby inhibiting or lessening the transmission of painful stimuli. This has been shown to have clinical utility for painful injections and other IOPs as evidenced by reduced perception of pain during procedures when low-frequency vibration is administered. For example, vibration applied to areas surrounding the site of laryngology procedures can provide stimulation to reduce discomfort. In a study by the inventors, vibratory stimulation was shown to improve the patient experience during in-office trans-cervical laryngeal Botox injection for the treatment of dysphonia. This was demonstrated through a reduction in heart rate increase (when compared to the control/no stimulation group) during the procedure, which is an objective physiologic surrogate for pain and discomfort. Additionally, in that study all patients filled out a patient satisfaction survey at the conclusion of the procedure which demonstrated that 100% of the patients who used the vibratory device felt their experience was improved by use of the device.

This paradigm can be extended to other bodily procedures outside of the field of laryngology as well. This principle can be employed to reduce pain or discomfort during medical procedures and has previously been employed for venipuncture. The vibration on the skin can alleviate sharp pain associated with inserting an intravenous catheter, taking a blood sample, receiving an injection, or accessing a port with a needle stick. This has been found to be effective at reducing pain levels as measured using validated metrics such as the Visual Analogue Scale (VAS), the Wong-Baker Scale (WBS), and the Numeric Rating Scale (NRS).

Another type of stimulation that can distract from painful stimulus is acoustic distraction. In prior studies, patients were provided nature sounds to listen to before, during and after a procedure while looking at a nature mural. Compared to the control group, patients in the image and acoustic distraction group reported significantly better pain control during flexible bronchoscopy.

Another mechanism to improve patient experience is virtual distraction. The virtual simulation model that a patient experiences and interacts with serves to give a feeling of an alternate reality and as the patient's attention is increasingly focused on that reality, perceived pain, discomfort, anxiety, and stress decreases. For example, VR can be utilized by patients either before or during procedures. Studies have uniformly shown decreased patient anxiety, decreased stress, improved comfort, and/or decreased perception of pain. Augmented reality (AR) is a variation of VR, in which the user of an AR system always experiences their own reality (real world view) in real-time with augmentation in the form of displays, information, or other visual effects provided through a headset. This is in contrast to VR, in which the visual environment of the user is completely synthetic and thus the user is separated from reality. Compared to VR, there has been less investigation of AR use by patients, however the literature shows the same efficacy and head-to-head studies have shown no significant difference between them. When combined with acoustic stimulation, a more complete VR/AR experience can be presented to the patient. In addition to AR, mixed reality (MR) extends AR by allowing the augmentation to interact with the real-world environment. In MR, the user can see and interact with both digital and physical elements. An umbrella term called extended reality (XR) can cover these different technologies: VR, AR, and MR.

For IOPs, AR headsets hold specific, clear advantages over VR headsets; namely, they are cheaper, use faster/easier to program software, allow for greater patient interaction and instruction, and are significantly smaller in overall size and facial footprint. The smaller sizes of AR headsets yield specific benefits for medical procedures in which access to facial structures, such as the oral cavity and neck, in addition to the rest of the body.

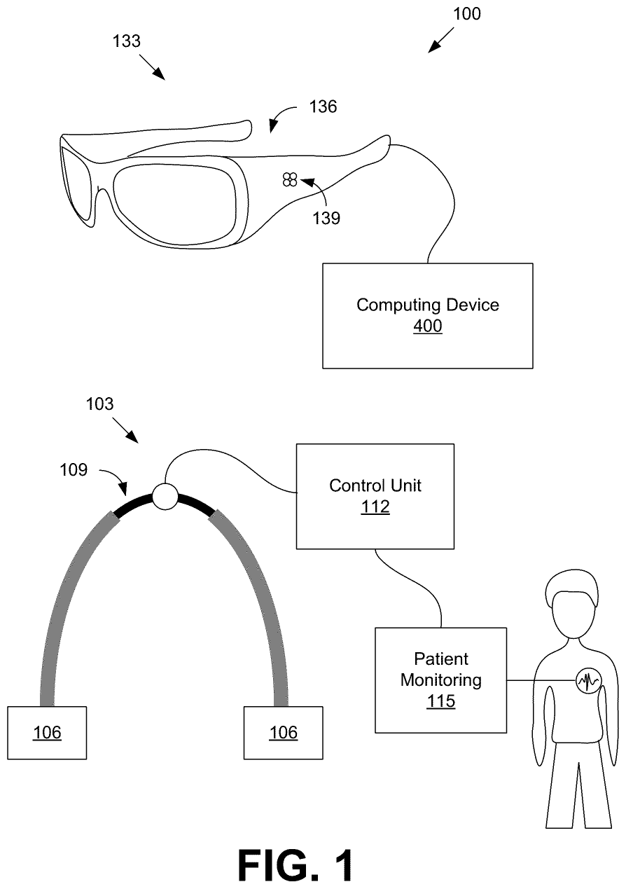

Next, a single or multisensory system is described that can be utilized by a patient to improve the experience and tolerability of an IOP. Referring to FIG. 1, illustrated is an example of a single or multisensory system 100 including one or a combination of a vibratory array 103 and/or an AR system 133 which can provide visual stimulation with (or without) accompanying acoustics. The vibratory array 103 can be a wearable vibratory array or can be an array mounted or supported by another structure (e.g., using an articulating arm that is applied to the patient's skin and affixed to a hospital bed, wall, and/or free on wheels). The vibratory array 103 can comprise one or more vibration sources 106 that can be positioned about the site of the procedure and held in place by a structure 109 supporting the vibration sources 106. The vibration sources 106 can be placed at various positions in proximity to the site of the procedure. For example, the vibration sources 106 can be located on opposite sides of the procedure site, on the same side of the procedure site, or in other distribution that can provide an effective result. A control unit 112 can control operation of the vibration sources 106 allowing for adjustment of the frequency and/or amplitude of the vibration based upon the stress or anxiety of the individual. In some implementations, patient monitoring 115 (e.g., heart rate, EKG or other stress or anxiety monitoring) can be provided to allow feedback to the control unit 112, which can be used to control operation of the vibration sources 106. Sensors can be positioned on the patient to monitor indications of, e.g., stress, pain, discomfort, and/or anxiety. For example, sensors can be affixed to the wrist or chest of the patient (e.g., using a smart watch or other sensor array) for detecting heart rate or other conditions. The monitored signals can be communicated to the control unit 112 through a wired or wireless connection. The AR system 133 can include an AR headset 136 (e.g., goggles or glasses) in communication with a computing device 400 to provide visual stimulation to the patient during the procedure. Other screens/monitors that are not worn, but instead mounted somewhere within the patient's field of view, can also be utilized. The AR headset can be communicatively coupled to the computing device 400 through a wireless or wired connection. The AR headset 136 can include speaker(s) 139 on one or both sides to provide acoustic stimulation. In some implementations, the vibratory array 103 can be included in the AR headset 136. Interaction with the alternate reality provided by the AR system 133 increases the patient's focus on the visual and/or acoustic stimulation, which can decrease the perceived pain.

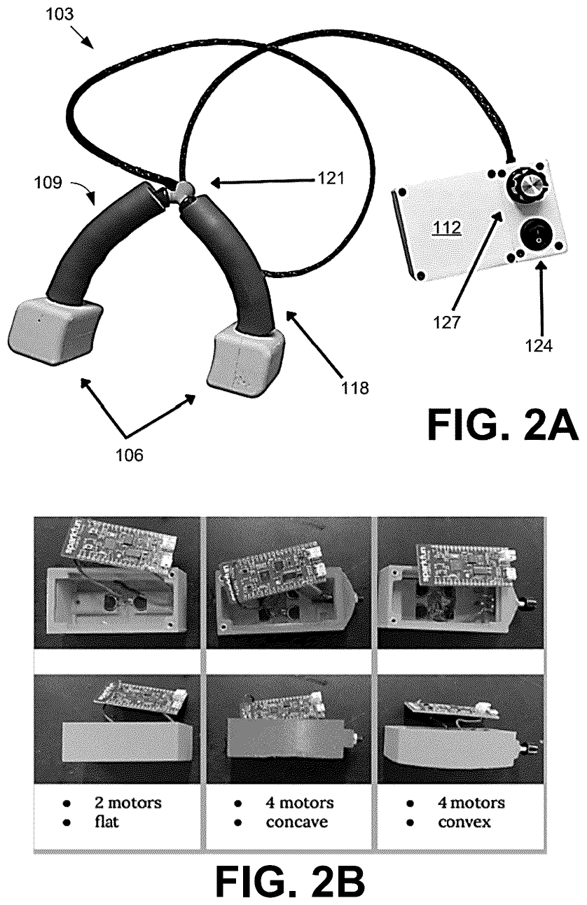

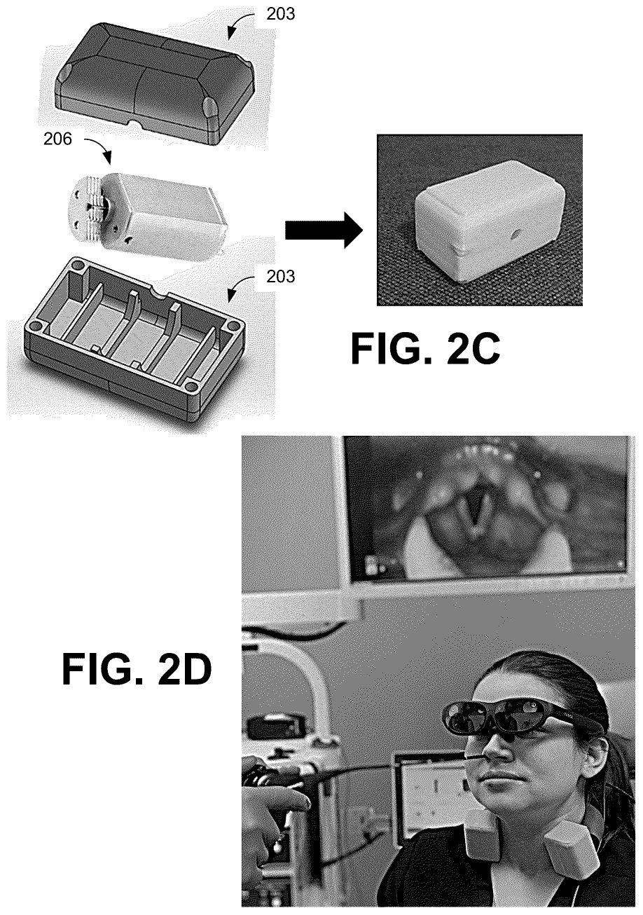

FIG. 2A is an image of an implemented vibratory array 103. In the example of FIG. 2A, the vibratory array 103 includes first and second vibration sources 106 that are coupled to a flexible support structure 109. In other implementations, additional vibration sources 106 can be included. The vibration sources 106 comprise a housing or casing that includes one or more electrical drives that can be controlled to produce the vibrations. The electrical drives can be, e.g., rotary or linear motors that can be driven to produce the vibrations, solenoid devices, piezoelectric device or other appropriate vibrational drive. For example, the motors can be DC or AC vibration motors with an unbalance to produce the vibration. In some cases, the motors can be switched to provide a vibrational force. In addition to the electrical drives, the housing or casing can also include circuitry for the electrical drives. FIG. 2B illustrates examples of different vibration sources 106, which can include different numbers of electrical drives as illustrated. The shape of the housing or casing can also be varied to conform with the same of the body surface and improve contact for vibration transmission. In FIG. 2B, flat, concave, and convex surfaces are illustrated.

In one example, the vibration sources 106 use two 6V 37 mA DC vibration motors. To enclose the motor, a two-piece case was designed in SolidWorks and 3D-printed with polylactic acid (PLA) on, e.g., a Creality Ender 3 V2 3D printer. FIG. 2C is an image of the fabricated motor casing comprising two pieces 203 that are joined together using a clasping mechanism to enclose the DC vibration motor 206, which is coupled to an unbalanced load. To form the adjustable support structure 109, the motor casing was attached to a segment of ¼″ Loc-Line® modular hose using a 2-part epoxy. The casing can be covered with a coating that facilitates transmission of the vibrations while protecting the skin of the patient. A silicone cover was created around the motor casing using a custom two-part mold that was designed and 3D printed. The mold was designed to bolster the motor casing, allowing the surrounding space to be filled with Mold Max™ 30 silicone rubber. A silicone casing with a Shore A hardness of 30 was chosen as the interface between the vibratory components and the skin to prevent any abrasion or discomfort. Once cured, the silicone was measured with a Shore A durometer to have a hardness of 30.5. Other appropriate coating materials can also be utilized.

To join the two vibratory components and complete the adjustable support structure 109, a narrow modular hose was used to provide both the rigidity and flexibility needed to make the vibratory array 103 wearable. The hose allows the vibratory array 103 to expand (e.g., to a distance of about 10 inches but can be increase by increasing the length of modular hose), accommodating a range of neck, legs, arms, and other discrete body part sizes to allow for wearability. Both segments of modular hose were covered with foam tubing 118 and connected with a Loc-Line® Wye Connector 121. The modular hose was covered in the foam tubing 118 to prevent pinching of the patient's hair or skin. The vibratory array 103 is easily wiped down with hospital-grade sanitizing wipes. The portion of the vibratory array 103 that sits on the neck (or other body part) is lightweight, weighing only 9.2 ounces.

In the example of FIG. 2A, the motors of the vibration sources 106 are wired in parallel to four AA batteries, which are located in the control unit 112. In other implementations, the power source can be included in the vibration source 106. The control unit 112 comprises circuitry configured to control operation of the vibration sources 106. In FIG. 2A, the control unit 112 includes a control interface comprising an on/off switch 124 and a potentiometer 127 (e.g., a 2000 potentiometer) that can be used to control the vibration frequency and/or intensity. To assemble the vibratory array 103, the vibratory sources 106 can be connected to the control unit 112 by a length of wire or cable (e.g., 3.5 feet of wire) that can be protected with a braided sleeving. The length of wire allows for the patient to personally control the application of the vibrations through the vibration sensors 106. This personal control can help distract the individual's attention from the procedure that is being performed. In other implementations, the control unit 112 can be communicatively coupled to the vibration sources 106 through a wireless (e.g., Bluetooth™) connection.

In other implementations, the control unit 112 can be configured to adjust the vibrations of the vibration sources 106 based upon feedback provided through patient monitoring 115 as illustrated in FIG. 1. For example, heart rate, EKG, sweat levels or other indicators of stress, pain, discomfort and/or anxiety can be monitored and indications provided to the control unit 112. For instance, monitoring the variations in heart rate (variability between beats) can provided an indication of stress and/or perceived pain in the individual. The control unit 112 can be configured to adjust vibration frequency and/or amplitude in response to variations in the stress, perceived pain, and/or anxiety level in the patient. For example, the frequency can be increased as the monitored stress level increases. In some cases, when a defined level is reached or exceeded, a warning can be provided.

FIG. 2D is an image of the vibratory array 103 worn by an individual during a laryngoscopy IOP test case Laryngology is a medical subspecialty within the field of otolaryngology that treats diseases of the larynx. Due to advances in technology and techniques, procedures that treat these conditions, like vocal cord injection and laser ablation, can be performed safely as in-office procedures (IOPs) rather than operating room (OR) procedures, making laryngology a prime field for initial development and pilot testing. In a study carried out by the inventors, use of a vibratory array during trans-cervical laryngeal Botox injection was shown to decrease pain and discomfort during the procedure through both objective measurements (e.g., decrease in heart rate increase compared to control group during the procedure) and subjective measurements (e.g., 100% of patients in the vibratory array group felt it improved their experience during the procedure).

The vibration sources 106 are positioned on the body allowing access to the area for the procedure and are held in position by the adjustable support structure 109. The contour of the vibration sources 106 maintain good contact with the surface of the body. During the procedure, the patient is able to control the vibrations of the vibration sources 106 through the control unit 112. While the example of FIG. 2D is presented in the context of laryngoscopy, the vibratory array 103 can be designed for a wide range of applications for pain, discomfort, anxiety, and/or stress reduction. For example, vibratory arrays 103 can be utilized over or about the pelvis, limbs, the face/neck, the spine or anywhere else on the body of a human or other living creature. A plurality of vibration sources 106 can be contoured and positioned about an area to provide vibrational stimulation to distract a patient during a procedure. Positioning of the vibrational sources 106 can be varied depending on the procedure and location on the body, or based upon the patient's preference.

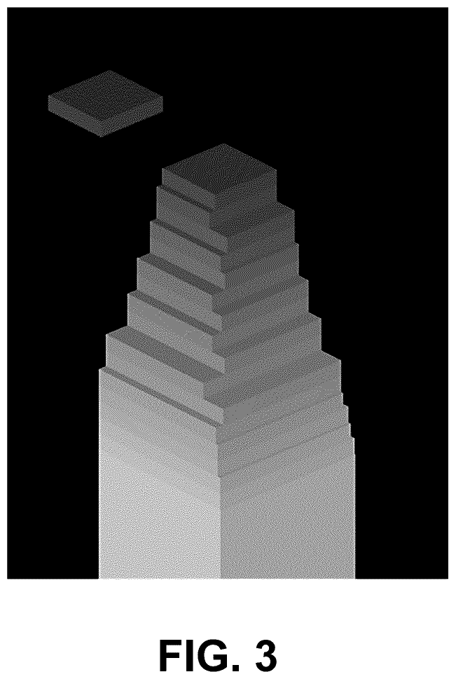

FIG. 2D also shows the individual wearing an AR headset 136 of the AR system 133. As previously discussed, the AR system can provide visual and/or acoustic stimulation and interaction with the patient during the procedure to divert attention away from the perceived pain and/or discomfort. Interaction can be through the AR headset 136 or through another user interface (e.g., controller) in communication with the computing device 400. An interactive game (“Stack3D”) was developed which helps focus attention away from the ongoing procedure. Stack3D is a simple stacking game developed with the Unity game engine using opensource code in the C# programming language. The game was configured using the Android software development kit to be compatible with the operating systems used in most AR devices. The game is played by clicking a button to drop a floating tile onto a stack. FIG. 3 shows an example of an image displayed during the game. Any part of the tile that extends past the stack falls off, decreasing the area onto which the tiles can stack. The player loses the game by failing to stack the tile. By keeping the game simple but challenging, the player remains focused without losing interest. This is just one example of interactive games that can be developed for use in the AR environment. Other AR experiences can include other games (for example, Flappy Butterfly games), short films, and/or scenes (for example, watching and listening to waves hitting the shore of a beach). Acoustic stimulation can also be provided through the AR headset 136 concurrent with the visual stimulation. The acoustic stimulation can be synchronized with the visual stimulation (e.g., films and/or scenes) or can be generated as part of the interactive game. For example, positive or negative acoustic feedback can be provided as part of the game.

A pilot study was performed to test whether or not multisensory stimulation could improve the patient experience during in-office trans-cervical laryngeal botox injection for the treatment of dysphonia. The study utilized the prototype in FIG. 2D. Patients were prospectively enrolled into a control arm, AR only arm, vibration on the neck only arm, and a combination of vibration and AR arm. Each arm had 12 to 14 patients enrolled. All patients wore an EKG to obtain an average heart rate before and during the procedure and all patients filled out a patient satisfaction survey at the conclusion of the procedure. Table 1 summarizes the study results of Arm 1 (Control group) and Arms 2, 3 and 4 (AR, Vibration (“Vib”), and AR+Vib groups respectively).

TABLE 1
Average Heart Rate (beats per minute)
Prior to and During In-Office Procedure

| | Arm 1: | Arm 2: | Arm 3: | Arm 4: |
|---|---|---|---|---|
| Variable | Control | AR | Vib | AR + Vib |
| Pre-procedure Average HR | 80.5 | 76.8 | 75.0 | 82.2 |
| During procedure Average HR | 86.0 | 80.4 | 77.8 | 80.9 |
| Change in Average HR | +5.5 | +3.6 | +2.8 | −1.3 |
| Pre vs During Average HR | 0.03 | 0.05 | 0.08 | 0.56 |
| (two tailed test p-value) | | | | |

Patients in Arm 1, the control, experienced a significant increase in their average heart rate during the procedure, indicative of increased stress or pain, while patients in Arms 2, 3, and 4 had no significant change in their heart rate during the procedure. Arm 4, the AR+ vibratory stimulation, had the smallest absolute change in HR as shown in Table 1. In the patient satisfaction survey, all patients were highly satisfied with their overall experience. Table 2 summarizes the satisfaction survey results. Notably, 100% of patients felt that the addition of vibratory stimulation and 92% of patients felt that the additional of AR and vibratory stimulation during the procedure improved their overall experience. In contrast, only 65% of patients felt that augmented reality alone improved their experience.

TABLE 2
Patient Satisfaction Survey

| | Arm 1: | Arm 2: | Arm 3: | Arm 4: | Anova |
|---|---|---|---|---|---|
| Question | Control | AR | Vib | AR + Vib | p-value |
| On a scale of 1-10 rate | 9.4 | 9.4 | 8.8 | 9.5 | 0.58 |
| your satisfaction | | | | | |
| Do you feel this device | — | 61.5% | 100% | 92% | |
| improved your | | | | | |
| experience (y/n) | | | | | |

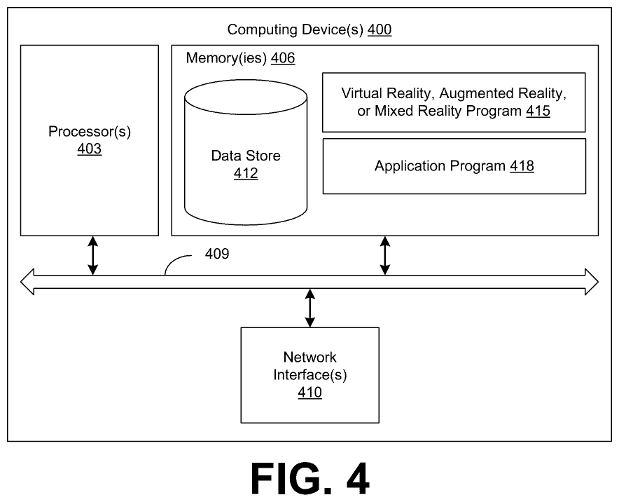

With reference to FIG. 4, shown is a schematic block diagram of a computing device 400 that can be utilized for execution of a virtual reality (VR), augmented reality (AR), or mixed reality (MR) application. In some embodiments, among others, the computing device 400 may represent a mobile device (e.g., a smartphone, tablet, computer, etc.). Each computing device 400 includes at least one processor circuit, for example, having a processor 403 and a memory 406, both of which are coupled to a local interface 409. To this end, each computing device 400 may comprise, for example, at least one server computer or like device. The local interface 409 may comprise, for example, a data bus with an accompanying address/control bus or other bus structure as can be appreciated. The computing device 400 can be communicatively coupled to one or more display devices configured to display information rendered by the computing device.

In some embodiments, the computing device 400 can include one or more network interfaces 410. The network interface 410 may comprise, for example, a wireless transmitter, a wireless transceiver, and a wireless receiver. As discussed above, the network interface 410 can communicate to a remote computing device using a Bluetooth protocol. As one skilled in the art can appreciate, other wireless protocols may be used in the various embodiments of the present disclosure. For example, the computing device 400 can communicate information to a user device for display through a user interface. The information can be rendered by the computing device 400 or by the user device for display.

Stored in the memory 406 are both data and several components that are executable by the processor 403. In particular, stored in the memory 406 and executable by the processor 403 are a virtual reality, augmented reality, or mixed reality program 415, application program 418, and potentially other applications. Also stored in the memory 406 may be a data store 412 and other data. In addition, an operating system may be stored in the memory 406 and executable by the processor 403.

It is understood that there may be other applications that are stored in the memory 406 and are executable by the processor 403 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 406 and are executable by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, source code that may be expressed in proper format such as object code that is capable of being loaded into a random access portion of the memory 406 and executed by the processor 403, or source code that may be interpreted by another executable program to generate instructions in a random access portion of the memory 406 to be executed by the processor 403, etc. An executable program may be stored in any portion or component of the memory 406 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 406 is defined herein as including both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 403 may represent multiple processors 403 and/or multiple processor cores and the memory 406 may represent multiple memories 406 that operate in parallel processing circuits, respectively. In such a case, the local interface 409 may be an appropriate network that facilitates communication between any two of the multiple processors 403, between any processor 403 and any of the memories 406, or between any two of the memories 406, etc. The local interface 409 may comprise additional systems designed to coordinate this communication, including, for example, performing load balancing. The processor 403 may be of electrical or of some other available construction.

Although the virtual reality, augmented reality, or mixed reality program 415 and the application program 418, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the virtual reality, augmented reality, or mixed reality program 415 and the application program 418, that comprises software or code can be embodied in any non-transitory computer-readable medium for use by or in connection with an instruction execution system such as, for example, a processor 403 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the virtual reality, augmented reality, or mixed reality program 415 and the application program 418, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 400, or in multiple computing devices in the same computing environment. Additionally, it is understood that terms such as “application,” “service,” “system,” “engine,” “module,” and so on may be interchangeable and are not intended to be limiting.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

Therefore, at least the following is claimed:

1. A single or multisensory system, comprising:
a vibratory array comprising:
first and second vibration sources coupled to an adjustable support structure for positioning about a procedure site; and
a control unit communicatively coupled to the first and second vibration sources, where vibrational frequency of the first and second vibration sources is controlled by the control unit.

2. The single or multisensory system of claim 1, wherein the first and second vibration sources each comprise an electrical drive configured to generate vibrations at the vibrational frequency.

3. The single or multisensory system of claim 2, wherein the electrical drive is a DC vibration motor.

4. The single or multisensory system of claim 2, wherein the first and second vibration sources comprise a casing enclosing the electrical drive.

5. The single or multisensory system of claim 4, wherein the casing is sealed in a silicone cover.

6. The single or multisensory system of claim 5, wherein a surface of the casing is contoured to match a corresponding surface to which the vibrational source is applied.

7. The single or multisensory system of claim 6, wherein the casing comprises a concave surface.

8. The single or multisensory system of claim 1, wherein the vibratory array comprises a third vibration source.

9. The single or multisensory system of claim 1, wherein the control unit comprises a control interface configured to allow a user to control operation of the first and second vibrational sources.

10. The single or multisensory system of claim 1, wherein the control unit comprises a power source for the first and second vibrational sources.

11. The single or multisensory system of claim 1, comprising an augmented reality (AR) system comprising:
an AR headset comprising a speaker configured to provide acoustic stimulation; and
a computing device communicatively coupled to the AR headset, wherein the computing device is configured to executed applications to provide content for display on the AR headset.

12. The single or multisensory system of claim 11, wherein the computing device executes an interactive application for display on the AR headset.

13. A method for single or multisensory stimulation during an awake or minimal sedation procedure, comprising:
providing a vibratory array comprising:
first and second vibration sources coupled to an adjustable support structure; and
a control unit communicatively coupled to the first and second vibration sources, where vibrational frequency of the first and second vibration sources is controlled by the control unit;
positioning the first and second vibration sources on an individual about a procedure site; and
adjusting the vibrational frequency of the first and second vibration sources based upon stress, pain, discomfort, or anxiety level of the individual during the awake or minimal sedation procedure.

14. The method of claim 13, wherein a surface of the first and second vibration sources is contoured to match a surface of the first and second vibration sources are applied.

15. The method of claim 13, wherein the first and second vibration sources are positioned on opposite sides of the procedure site.

16. The method of claim 13, wherein the vibrational frequency is adjusted by the individual based upon their sensed stress or anxiety level.

17. The method of claim 16, wherein the control unit comprises a user interface configured to allow the individual to control operation of the first and second vibrational sources.

18. The method of claim 13, wherein the control unit adjusts the vibrational frequency based upon feedback provided through patient monitoring.

19. The method of claim 13, further comprising:
positioning an AR headset on the individual; and
providing content for display on the AR headset during the awake or minimal sedation procedure.

20. The method of claim 19, wherein the content is interactive content prompting feedback from the individual.
